(19) United States
(12) Patent Application Publication
(10) Pub. No.: US 2025/0220404 A1
(43) Pub. Date: Jul. 3, 2025

(54) Network Device with Device Discovery and Onboarding Capabilities

(71) Applicant: Cisco Technology, Inc., San Jose, CA (US)

(72) Inventors: Ugo Campiglio, ECUBLENS (CH); Jerome Henry, Pittsboro, NC (US); Indermeet Gandhi, San Jose, CA (US); Domenico Ficara, Essertines-sur-Yverdon (CH); Robert Barton, VANCOUVER (CA)

(21) Appl. No.: 18/798,571

(22) Filed: Aug. 8, 2024

Related U.S. Application Data
(60) Provisional application No. 63/615,209, filed on Dec. 27, 2023.

(51) Int. Cl. H04W 8/00; H04W 28/26

(52) U.S. Cl. CPC H04W 8/005; H04W 28/26

(57) ABSTRACT

Devices, systems, methods, and processes for discovering and onboarding network devices are described herein. Integrating device discovery and onboarding mechanisms in a network device, especially in the presence of legacy devices, is a complex challenge. A device discovery logic, configured in a network device, facilitates transmission of a discovery frame comprising one or more bitmasks. Each bitmask is associated with a corresponding response slot and also has a unique identifier pattern or sub-pattern. Devices having device identifiers that match these bitmasks respond in designated response slots. If no response is received in any response slot, the discovery frame is retransmitted by adjusting a transmission power or a new discovery frame with new bitmasks is transmitted. Additionally, the network device can energize ambient power devices using radio frequency signals before transmitting the discovery frame. This adaptive approach ensures efficient and organized device discovery and onboarding, minimizing collisions and optimizing network configuration.

The present disclosure relates to wireless communication. More particularly, the present disclosure relates to network devices with device discovery and onboarding capabilities.

This application claims the benefit of U.S. Provisional Patent Application No. 63/615,209, filed Dec. 27, 2023, which is incorporated by reference herein in its entirety.

### BACKGROUND

The next generation of wireless technology in the 802.11 framework offers significant enhancements in data transmission speeds and range compared to its predecessors. Additionally, the Ambient Power Study Group (AMP SG) within the IEEE 802.11 framework is focused on supporting a higher number of devices per access point (AP), addressing the increasing demand for robust and scalable wireless networks.

In practical scenarios, AMP devices operating in the 2.4 GHz band can interfere with legacy devices also operating in the 2.4 GHz band. The intermittent activity and variable duty cycles of AMP devices can lead to unpredictable traffic patterns, which may degrade the performance of legacy devices. To mitigate this issue, the AMP devices are authorized to communicate with the AP only when polled. This polling mechanism allows the AP to manage communication windows of the AMP devices, ensuring that their transmissions do not overlap excessively with those of legacy devices, thereby minimizing potential interference.

For the polling mechanism to be effective, the AP must first discover and onboard the AMP devices in an efficient manner. This involves a discovery process where the AP identifies the presence of AMP devices within its range and subsequently onboards them by assigning necessary network parameters and schedules for communication. The challenge lies in performing these onboarding tasks for a large number of AMP devices without significantly disrupting the ongoing communications of legacy devices.

### SUMMARY OF THE DISCLOSURE

Systems and methods for facilitating discovery and onboarding of network devices in accordance with embodiments of the disclosure are described herein. In some embodiments, a device includes a processor, a network interface controller configured to provide access to a network, and a memory communicatively coupled to the processor, wherein the memory includes a device discovery logic that is configured to identify one or more bitmasks, generate a discovery frame including the one or more bitmasks, transmit the discovery frame, and discover a network device in response to transmitting the discovery frame, wherein the discovered network device has an identifier that matches a bitmask among the one or more bitmasks.

In some embodiments, the device discovery logic is further configured to assign a response slot for each of the one or more bitmasks.

In some embodiments, the one or more bitmasks are listed in a defined order within the discovery frame.

In some embodiments, the device discovery logic is further configured to assign the response slot for each of the one or more bitmasks in the defined order in which the one or more bitmasks are listed within the discovery frame.

In some embodiments, the device discovery logic is further configured to receive a response from the network device.

In some embodiments, the network device is discovered based on the received response.

In some embodiments, the response is received within the response slot assigned to the bitmask that matched the identifier of the network device.

In some embodiments, the device discovery logic is further configured to detect a collision of a plurality of responses in the response slot assigned to at least one other bitmask among the one or more bitmasks, identify one or more new bitmasks based on the at least one other bitmask, generate a first new discovery frame including the one or more new bitmasks, and transmit the first new discovery frame.

In some embodiments, the device discovery logic is further configured to determine whether at least one new response is received for the first new discovery frame.

In some embodiments, in absence of the at least one new response, the device discovery logic is further configured to increase a signal transmission power, and re-transmit the first new discovery frame with the increased signal transmission power.

In some embodiments, the device discovery logic is further configured to refine the one or more new bitmasks in absence of the at least one new response, generate a second new discovery frame including the refined one or more new bitmasks, and transmit the second new discovery frame.

In some embodiments, prior to transmitting the discovery frame, the device discovery logic is further configured to transmit one or more Radio Frequency (RF) signals, and wherein the one or more RF signals are configured to energize an ambient power device located within a communication range of the device.

In some embodiments, the network device is the ambient power device.

In some embodiments, transmitting the discovery frame includes broadcasting the discovery frame.

In some embodiments, to transmit the discovery frame, the device discovery logic is further configured to transmit one or more beamformed signals carrying the discovery frame.

In some embodiments, the device discovery logic is further configured to indicate an epoch duration and a response slot duration along with the discovery frame, and wherein the epoch duration corresponds to a total amount of time allocated for receiving one or more responses to the discovery frame.

In some embodiments, the device discovery logic is further configured to reserve a network allocation vector (NAV) for the epoch duration.

In some embodiments, a device discovery logic is configured to receive a discovery frame including one or more bitmasks, compare the one or more bitmasks with a device identifier, generate a response based on a match between the device identifier and a bitmask of the one or more bitmasks, and transmit the response.

In some embodiments, the device discovery logic is further configured to identify a response slot associated with the bitmask that matched the device identifier, and wherein the response is transmitted within the response slot.

In some embodiments, a method includes identifying one or more bitmasks, generating a discovery frame including the one or more bitmasks, transmitting the discovery frame, and discovering a network device in response to transmitting the discovery frame, wherein the discovered network device has an identifier that matches a bitmask among the one or more bitmasks.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently preferred embodiments of the disclosure. As such, various other embodiments are possible within its scope. Accordingly, the scope of the disclosure should be determined not by the embodiments illustrated, but by the appended claims and their equivalents.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a conceptual network diagram of various environments that implement a device discovery logic in accordance with various embodiments of the disclosure;

FIG. 2 is an example diagram that illustrates a discovery cycle executed by an Access Point (AP) in accordance with various embodiments of the disclosure;

FIG. 3 is an example diagram that illustrates an example scenario of progressively increasing AP transmission power in each device discovery cycle in accordance with various embodiments of the disclosure;

FIG. 4 is a flowchart showing a process for discovering and onboarding a network device by an AP in accordance with various embodiments of the disclosure;

FIG. 5 is a flowchart showing a process for discovering and onboarding a network device by an AP in accordance with various embodiments of the disclosure;

FIG. 6 is a flowchart showing a process for discovery of one or more network devices with similar identifiers in accordance with various embodiments of the disclosure;

FIG. 7 is a flowchart showing a process for transmitting a discovery frame by dynamically adjusting a transmission power in accordance with various embodiments of the disclosure;

FIG. 8 is a flowchart showing a process onboarding one or more ambient power (AMP) devices by an AP in accordance with various embodiments of the disclosure;

FIG. 9 is a flowchart showing a process for responding to a discovery frame by a network device in accordance with various embodiments of the disclosure; and

FIG. 10 is a conceptual block diagram of a device suitable for configuration with a device discovery logic, in accordance with various embodiments of the disclosure.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### DETAILED DESCRIPTION

In response to the situations described above, devices and methods are discussed herein that can facilitate discovery and subsequent onboarding of ambient power (AMP) devices by access points (APs). The Ambient Power Study Group (AMP SG) within the IEEE 802.11 framework is focused on supporting a higher number of devices (e.g., AMP devices) per AP, addressing the increasing demand for robust and scalable wireless networks. In practical scenarios, an AMP device operating in the 2.4 GHz band can interfere with legacy devices also operating in the 2.4 GHz band. For example, the intermittent activity and variable duty cycles of AMP devices can lead to unpredictable traffic patterns, which may degrade the performance of legacy devices. To mitigate this issue, the AMP devices are authorized to communicate with the AP only when polled. This polling mechanism allows the AP to manage communication windows of the AMP devices, ensuring that their transmissions do not overlap excessively with those of legacy devices. For the polling mechanism to be effective, the AP must first discover and onboard the AMP devices in an efficient manner. This involves a discovery process where the AP identifies the presence of AMP devices within its range and subsequently onboards them by assigning necessary network parameters and schedules for communication. However, the challenge lies in performing these onboarding tasks for a large number of AMP devices without significantly disrupting the ongoing communications of legacy devices.

The present disclosure provides an AP (e.g., a network device) with enhanced device discovery and onboarding capabilities. In many embodiments, an AP may be configured to send data to and receive data from a plurality of AMP devices in a network. “AMP device” may refer to a network device that can harness ambient energy sources (for example, solar, thermal, or radio frequency “RF” energy) to power its operations, reducing reliance on traditional power supplies and enhancing sustainability. The AMP devices may include, for example, solar-powered Internet-of-Things (IoT) devices, thermal energy harvesting sensors, RF energy harvesting devices, piezoelectric energy harvesting units, ambient light-powered indoor sensors, small-scale wind energy harvesting devices, or the like.

In a number of embodiments, to be able to send data to and receive data from the plurality of AMP devices, the AP is first required to discover and onboard the plurality of AMP devices. The AP may include a device discovery logic configured to facilitate discovery and onboarding of the plurality of AMP devices. In various embodiments, the AP may identify one or more bitmasks to discover various AMP devices in the network. “Bitmask” may refer to a sequence of bits used to extract or manipulate specific bits within another binary sequence. Bitmask may be an identifier mask that an AMP device can apply to its unique device identifier and check if the device identifier matches with the bitmask. Thus, to discover an AMP device with a device identifier that matches certain criteria, the AP may encode the criteria into a bitmask. For example, to discover an AMP device from a specific vendor, the AP may identify a bitmask having an Organizational Unique Identifier (OUI) of the vendor encoded into it. If the unique identifier is a Media Access Control (MAC) address and the OUI of the vendor is “ABC”, a bitmask can be identified as “ABC-ffffff”. Likewise, to discover an AMP device from a specific vendor and having a least significant bit as “0”, a bitmask can be identified as “ABC-fffff0”. In other words, each of the one or more bitmasks may represent a unique identifier pattern or sub-pattern that the AP utilizes to discover a matching AMP device. In an example, the AP may employ an adaptive mask optimization scheme to identify or adjust the one or more bitmasks based on already discovered devices. For example, directed bitmasks may be used for devices with completely known identifiers while broad bitmasks may be used for devices with unknown identifiers.

In a variety of embodiments, the AP may generate a discovery frame including the one or more bitmasks. The one or more bitmasks may be listed in a defined order within the discovery frame. The AP may be further configured to transmit the discovery frame. In many examples, the AP may broadcast the discovery frame. In further examples, the AP may transmit the discovery frame via one or more beamformed signals. In many further examples, for enhanced precision, the AP may utilize directional discovery mechanisms such as sweeping a localized beam, phased array steering of transmission power, or the like to narrowcast the discovery frame. The AP may transmit the discovery frame with a predefined transmission power. In an instance, apart from the one or more bitmasks, the discovery frame may further include a service set identifier (SSID), one or more supported standards, a plurality of security settings, or the like.

In additional embodiments, the AP may be configured to assign a response slot for each of the one or more bitmasks in the same defined order in which the one or more bitmasks are listed within the discovery frame. In more embodiments, the AP may further specify a response slot duration for each response slot and an epoch duration, in the discovery frame. The epoch duration may represent the total time allocated for receiving responses. In yet more embodiments, the response slots may be separated by set time intervals to manage responses efficiently.

In further embodiments, the AP may reserve a network allocation vector (NAV) for the epoch duration, ensuring orderly and efficient communication within the allocated timeframe. The term “NAV” may refer to a timer mechanism in wireless networks that reserves a communication medium (e.g. the network channel) for a specified duration to prevent collisions and manage access. By reserving the NAV for the epoch duration, the AP announces its unavailability during the epoch duration for communicating with other connected devices.

In still more embodiments, when an AMP device receives the discovery frame, the AMP device may compare corresponding device identifier with the one or more bitmasks. In a scenario, if the device identifier matches any of the one or more bitmasks, the AMP device may be configured to generate a response. The AMP device may further identify a response slot associated with the bitmask that matched the device identifier and transmit the response within the identified response slot. If the AMP device is already onboarded with the AP, the AMP device may discard the discovery frame, preventing redundant communication.

In numerous embodiments, the AP, upon receiving the response from the AMP device within the designated response slot, may establish communication with the discovered AMP device. In various embodiments, the AP may establish the communication by transmitting an authentication request to the discovered AMP device and thereby receiving an authentication response from the discovered AMP device. The authentication response can be verified by the AP and the discovered AMP device is onboarded upon successful verification.

In still further embodiments, two or more AMP devices may transmit responses in the same response slot if identifiers of the two or more AMP devices match the same bitmask, causing collision in the response slot. The AP may be configured to detect such collisions in the response slot and identify one or more new bitmasks based on the matching bitmask to differentiate between the colliding AMP devices. In other words, the AP may refine (for example, narrow down) the matching bitmask to identify the one or more new bitmasks. The AP may then generate a new discovery frame including the one or more new bitmasks to discover the colliding two or more AMP devices. The AP may repeat the discovery process using the new discovery frame.

In further additional embodiments, in order to reduce the number of collisions during device discovery, the AP can gradually increase signal transmission power across different discovery cycles. For example, initially, the AP may transmit a discovery frame utilizing low transmission power, allowing only very close AMP devices to respond and be onboarded. Gradually, the AP may increase the signal transmission power in subsequent discovery cycles and re-transmit the same discovery frame. Thus, extending its reach to discover AMP devices that are located further away. This process may be repeated until all devices corresponding to the discovery frame are discovered. Consequently, the AP may generate a new discovery frame and repeat the entire process for the new discovery frame. Such transmission power adjustment reduces the likelihood of multiple devices responding simultaneously in the same response slot, thereby enabling the AP to discover multiple devices in the network more effectively while minimizing collisions.

In many further embodiments, the AP may not receive any response within certain response slots or all response slots associated with a discovery frame. For example, AMP devices in the network may be outside a current discovery range of the AP or no AMP device may have a matching identifier. If even at the maximum transmission power the AP does not receive any response within certain or all response slots, the AP may determine that no AMP device with the matching identifier is in the communication range of the AP. The AP may then identify new bitmasks and repeat the discovery and onboarding process using the new bitmasks. The AP may execute the discovery and onboarding process until all bitmask options are exhausted.

In numerous additional embodiments, prior to transmitting the discovery frame, the AP may transmit one or more RF signals to energize one or more AMP devices located within its communication range. In some more embodiments, the AP may take advantage of localized beam sweeping and may reduce the number of active AMP devices responding in a discovery cycle. For example, the AP can utilize directional RF beams to selectively energize AMP devices located in a specific area. As a result, even when the AP transmits the discovery frame at the maximum transmission power, only the energized AMP devices within the targeted volume or space would respond. Thus, reducing the likelihood of collision.

Thus, the AP can ensure seamless integration of both modern and legacy devices, allowing older devices to coexist and function within the wireless network without significant performance degradation. By efficiently managing the discovery cycles through NAV reservation, the AP can maintain a higher overall network efficiency and speed. Further, the AP can dynamically allocate resources and adjust parameters such as transmission power and response slot duration, ensuring that both legacy and modern devices receive fair access to network resources. Thus, the AP can collectively improve the overall performance, compatibility, and longevity of the network infrastructure, providing a robust solution for environments with mixed device generations.

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.” Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom VLSI circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer-readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in still yet more embodiments, may alternatively be embodied by or implemented as a component.

A circuit, as used herein, comprises a set of one or more electrical and/or electronic components providing one or more pathways for electrical current. In many additional embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

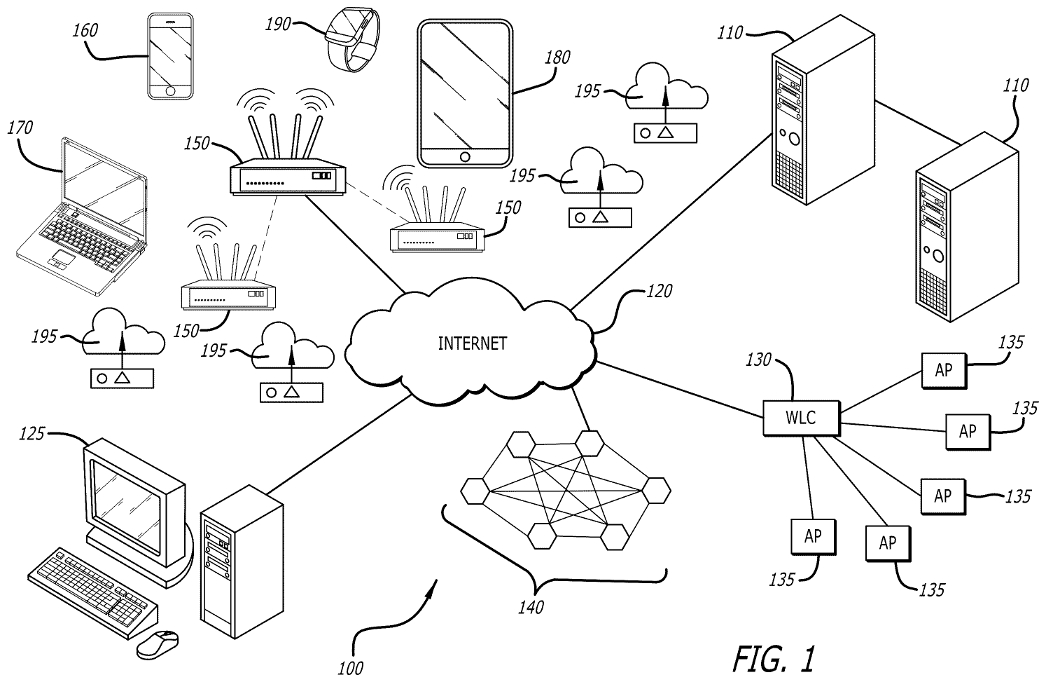

Referring to FIG. 1, a conceptual network diagram of various environments that implement a device discovery logic in accordance with various embodiments of the disclosure is shown. The device discovery logic can include various hardware and/or software deployments and can be configured in a variety of ways. In some non-limiting examples, the device discovery logic can be configured as a standalone device, exist as a logic within another network device, be distributed among various network devices operating in tandem, or remotely operated as part of a cloud-based network management tool. The embodiments shown in FIG. 1 illustrate a network 100 comprising a plurality of network devices that can implement the device discovery logic for discovering and onboarding other network devices.

In many embodiments, the network 100 may include cloud-based centralized management servers 110 connected to a communication network 120 (shown as the Internet). The communication network 120 can include wired networks or wireless networks. The centralized management servers 110 can be configured to execute the device discovery logic. In a variety of embodiments, the network 100 may further include remote networks, such as, but not limited to a deployed network 140.

In a number of embodiments, the network 100 may include a plurality of network access points (APs) 150. The APs 150 may facilitate Wi-Fi connections for various electronic devices, such as but not limited to, mobile computing devices including laptop computers 170, cellular phones 160, portable tablet computers 180, wearable computing devices 190, and ambient power (AMP) devices 195. The AMP devices 195 may refer to those network devices that can harness ambient energy sources (for example, solar, thermal, or radio frequency “RF” energy) to power their operations. Thus, reducing reliance on traditional power supplies and enhancing sustainability. The AMP devices 195 may include, for example, solar-powered Internet-of-Things (IoT) devices, thermal energy harvesting sensors, RF energy harvesting devices, piezoelectric energy harvesting units, ambient light-powered indoor sensors, small-scale wind energy harvesting devices, or the like. The APs 150 can be configured to execute the device discovery logic. However, in further embodiments, the device discovery logic may be operated as distributed logic across multiple APs 150. In the embodiment depicted in FIG. 1, the plurality of network APs 150 can operate as the device discovery logic in a distributed manner or may have one specific AP to implement the device discovery logic for the various APs.

In more embodiments, the network 100 may include a wireless Local Area Network (LAN) controller (WLC) 130 configured to monitor or control power consumption of APs 135 connected to the WLC 130, either wired or wirelessly. The WLC 130 and/or the APs 135 can be configured to execute the device discovery logic. In still more embodiments, a personal computer 125 may be utilized to access and/or manage various aspects of the network 100, either remotely or within the network itself. In the embodiment depicted in FIG. 1, the personal computer 125 may communicate over the communication network 120 and can access the servers 110, the network APs 150, or the WLC 130.

For the sake of ongoing description, execution of the device discovery logic is described with respect to an AP 150. In an example scenario, the AP 150 may need to discover various AMP devices 195 that are present within the network 100 and also within a communication range of the AP 150. The AP 150 may utilize the device discovery logic to discover such AMP devices 195. Based on the device discovery logic, the AP 150 may execute one or more discovery cycles to discover and onboard the AMP devices 195. In many examples, the AP 150 can execute periodic discovery cycles to discover the AMP devices 195 that are present within the communication range of the AP 150.

In yet more embodiments, in a discovery cycle, the AP 150 may generate a discovery frame, including one or more bitmasks, and transmit the discovery frame for discovering the AMP devices 195. The one or more bitmasks may be listed in a defined order within the discovery frame. The discovery frame may be transmitted in a message format that is understandable by both AMP and non-AMP devices. In still yet more embodiments, the AP 150 may assign an epoch duration in which nearby AMP devices 195 can respond to the discovery frame. The epoch duration may include multiple response slots, one assigned for each bitmask. For example, the AP 150 may assign a response slot for each of the bitmasks in the same defined order in which the bitmasks are listed within the discovery frame. In these embodiments, each response slot is assigned for a predefined slot duration. For example, the AP 150 may configure the predefined slot duration to be a tick speed that indicates how long each response of an AMP station is expected to last.

In many further embodiments, the AP 150 may be configured to reserve a network allocation vector (NAV), for a total amount of time, starting from the transmission of the discovery frame to the end of the epoch duration, to prevent other connected devices from transmitting data to the AP 150. For example, when the AP 150 sends a discovery frame with an epoch duration of 200 milliseconds, connected devices that receive the discovery frame may set their respective NAV timers to 200 milliseconds, preventing the connected devices from transmitting data to the AP 150 until their NAV timer times out.

In still additional embodiments, the AP 150 may identify the one or more bitmasks (hereinafter, “the bitmasks”) and list the bitmasks in the defined order within the discovery frame. Bitmask may be an identifier mask that an AMP device can apply to its unique device identifier. Thus, to discover an AMP device with a device identifier that matches certain criteria, the AP 150 may encode the criteria into a bitmask. In an example, the AP 150 may identify the bitmasks by utilizing, adaptive mask optimization techniques, machine learning algorithms, clustering algorithms, reinforcement learning, hybrid probing techniques, or the like. The AP 150 may identify a directed mask for one or more AMP devices with known identifiers while identifying a broad mask to discover AMP devices with unknown identifiers.

A device identifier may be a unique identifier assigned to a device for the purpose of identification and communication within the network 100. The device identifier can take various forms, such as a Media Access Control (MAC) address, a serial number, or other proprietary identification numbers. In an example, the device identifier can be a MAC address. MAC address typically includes six groups of two hexadecimal digits. For example, 00:1A:2B:3C: 4D:5E is a MAC address where the first three groups (00:1A:2B) represent the Organizational Unique Identifier (OUI) assigned to the manufacturer/vendor, and the last three groups (3C:4D:5E) are unique to the device itself. In other examples, the device identifier can be a serial number. A serial number typically includes an alphanumeric string assigned to a device by the manufacturer. For example, Ser. No. 12/345,678 may be a serial number for a specific model of a device.

Therefore, to discover an AMP device from a specific vendor, the AP 150 may identify a bitmask having an OUI of the vendor encoded into it. If the unique identifier is a MAC address and the OUI of the vendor is “ABC”, a bitmask can be identified as “ABC-ffffff”. Thus, the bitmask includes certain placeholder characters (represented by ‘f’) and specific characters that must match exactly in corresponding positions of the device identifiers. Likewise, to discover an AMP device from a specific vendor “ABC” and having a least significant bit as “0”, a bitmask can be identified as “ABC-fffff0”. In other words, each bitmask may include a unique identifier pattern or sub-pattern corresponding to an AMP device that the AP 150 wants to discover. This specific targeting may help in discovering devices based on their vendor and other specific characteristics. Moreover, the concept of bitmasks can extend beyond MAC addresses. For example, fire alarm sensors from a vendor might use an identifier format “Fn986-8digits,” where the 8 digits may represent the individual sensor identifier within the series. The bitmask “Fn998-ffffffff” could then be used to discover all fire alarm sensors from the vendor, facilitating their discovery and management within the network 100.

In some more embodiments, AMP devices 195 in the vicinity of the AP 150 may receive the discovery frame. An AMP station (e.g., any of the AMP devices 195) whose device identifier matches any of the bitmasks in the discovery frame and which has not been already associated with the AP 150 may transmit a response in a response slot corresponding to the matched bitmask. In other words, if the discovery frame includes a matching bitmask at a second position, the AMP device may transmit a response in a second response slot associated with the matching bitmask, thus, allowing the AP 150 to discover the AMP device. In other words, each responding AMP device may wait for its turn (e.g., the response slot) to respond.

In many further embodiments, the AP 150 may receive the response from the AMP device in response to transmitting the discovery frame. The AP 150 may then execute one or more operations for associating, authenticating, and configuring the discovered AMP device.

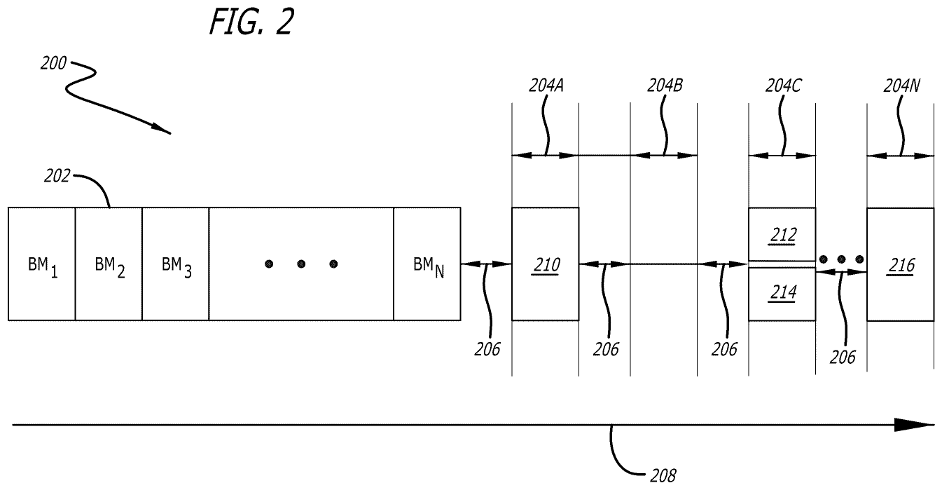

Although a specific embodiment for a conceptual network diagram of various environments that implement a device discovery logic suitable for carrying out the various steps, processes, methods, and operations described herein is discussed with respect to FIG. 1, any of a variety of systems and/or processes may be utilized in accordance with embodiments of the disclosure. For example, if the AP 150 does not receive any response for the discovery frame, the AP 150 may identify new bitmasks and generate a new discovery frame. The elements depicted in FIG. 1 may also be interchangeable with other elements of FIGS. 2-9 as required to realize a particularly desired embodiment.

Referring to FIG. 2, an example diagram 200 that illustrates a discovery cycle executed by an AP in accordance with various embodiments of the disclosure is shown. In an example as depicted in FIG. 2, an AP may transmit a discovery frame 202. In several embodiments, for transmitting the discovery frame 202, the AP may broadcast the discovery frame 202. In several additional embodiments, the AP may transmit the one or more beamformed signals carrying the discovery frame 202. In further embodiments, for enhanced precision, the AP may utilize directional discovery mechanisms such as sweeping a localized beam, phased array steering of transmission power, or the like to narrowcast the discovery frame 202.

In various embodiments, the discovery frame 202 may include “n” bitmasks (e.g., BM1, BM2, BM3 . . . , and BMn). The bitmasks BM1, BM2, BM3 . . . , and BMn may be listed in a defined order within the discovery frame 202.

In a variety of embodiments, the AP may assign “n” response slots (depicted by 204A, 204B, 204C . . . 204N) corresponding to the “n” bitmasks BM1, BM2, BM3 . . . , and BMn. A response slot may refer to a time-bound period assigned for receiving a response associated with a corresponding bitmask. The AP may assign a response slot for each of the bitmasks BM1, BM2, BM3 . . . , and BMn in the same defined order in which the bitmasks BM1, BM2, BM3 . . . , and BMn are listed within the discovery frame 202. For example, the bitmask BM1 is listed prior to another bitmask BM2. Consequently, the response slot 204A for the bitmask BM1 is temporally scheduled prior to the response slot 204B for the bitmask BM2.

In many embodiments, consecutive response slots 204A-204N can be separated by a Short Interframe Space (SIFS) (depicted by 206). SIFS 206 may refer to a predetermined period of time that occurs between two consecutive response slots. SIFS 206 may provide a short buffer interval to ensure clear separation between responses received within the response slots 204A-204N. In other words, the separation of consecutive response slots 204A-204N by SIFS 206 may ensure an orderly exchange of responses, enhancing the efficiency of the device discovery and onboarding process.

In additional embodiments, the AP may further specify a response slot duration for each response slot 204A-204N and an epoch duration. For example, the AP may specify the response slot duration for each response slot 204A-204N and the epoch duration, within the discovery frame 202. The epoch duration may represent the total time allocated to the response slots 204A-204N. In many additional embodiments, apart from the bitmasks BM1, BM2, BM3 . . . , and BMn, the discovery frame 202 may further include a service set identifier (SSID), one or more supported standards, a plurality of security settings, or the like.

In a number of embodiments, the AP may reserve an NAV (depicted by arrow 208) for an entire duration starting from the transmission of the discovery frame 202 till the end of the nth response slot 204N (e.g., the epoch duration). The NAV may refer to a virtual carrier sensing mechanism utilized in wireless networks to indicate a duration for which the communication medium is reserved. By reserving the NAV until the end of the nth response slot 204N, the AP may ensure that no other device attempts to communicate with the AP or accesses a frequency channel used by the AP during the discovery cycle.

In more embodiments, when an AMP device receives the discovery frame 202, the AMP device may compare a corresponding device identifier (for example, MAC address, serial number, or the like) with the bitmasks BM1, BM2, BM3 . . . , and BMn. In a scenario, if the device identifier matches any of the bitmasks BM1, BM2, BM3 . . . , and BMn, the AMP device may generate a response. The AMP device may further identify a response slot, among the response slots 204A-204N, associated with the bitmask that matched the device identifier. For example, a device identifier of a first AMP device may match the bitmask BM1. Based on the matching, the first AMP device may generate a first response 210. The first AMP device can then determine which of the response slots 204A-204N corresponds to the bitmask BM1. For example, the first AMP device may compute a SIFS order in the series based on the matching bitmask BM1 and determine that the response slot 204A corresponds to the bitmask BM1. Once the response slot 204A is determined by the first AMP device, the first AMP device may wait for a number of ticks associated with the response slot 204A and then transmit the first response 210 within the response slot 204A. Likewise, device identifiers of second and third AMP devices may match the bitmask BM3. Based on the matching, the second and third AMP devices may generate second and third responses 212 and 214, respectively. Both the second and third AMP devices may transmit the second and third responses 212 and 214 within the response slot 204C assigned to the bitmask BM3.

Consequently, in the response slot 204A, the AP may receive the first response 210 from the first AMP device whose device identifier matched BM1. The AP may discover and onboard the first AMP device based on the first response 210. Further, in the subsequent response slot 204B, the AP may not receive any response, indicating the bitmask BM2 did not match any device identifier. Furthermore, in the response slot 204C, the AP may receive the second and third responses 212 and 214 from the second and third AMP devices, respectively, resulting in a collision of a plurality of responses (e.g., the second and third responses 212 and 214) in the response slot 204C.

In further additional embodiments, the AP may detect the collision of the second and third responses 212 and 214 in the response slot 204C. Upon detecting a collision, the AP may identify one or more new bitmasks based on the bitmask BM3 that resulted in the collision. The one or more new bitmasks may correspond to narrower versions of the bitmask BM3 each trying to target the second and third AMP devices independently. For example, if the bitmask BM3 only had the vendor specific data, each of the one or more new bitmasks may include the same vendor specific data along with additional unique criteria that may be different in the second and third AMP devices.

In yet more embodiments, upon expiration of the nth response slot 204N, the AP may either initiate a subsequent discovery cycle or wait for some time and then initiate the subsequent discovery cycle. In the subsequent discovery cycle, the AP may transmit a new discovery frame including the one or more new bitmasks and may attempt to discover the second and third AMP devices. The AP may continue the fine-tuning process of bitmasks until all nearby AMP devices are discovered and onboarded.

In still more embodiments, prior to transmitting the discovery frame 202, the AP may be further configured to transmit one or more RF signals. The RF signals may be configured to energize all AMP devices located within a communication range of the AP. In some more embodiments, the AP may take advantage of localized beam sweeping and may reduce the number of active AMP devices responding in a discovery cycle. For example, the AP can utilize directional RF beams to selectively energize AMP devices located in a specific area. As a result, even when the AP transmits the discovery frame at the maximum transmission power, only the energized AMP devices within the targeted volume or space would respond. Thus, reducing the likelihood of collision.

Although a specific embodiment for a discovery cycle executed by an AP suitable for carrying out the various steps, processes, methods, and operations described herein is discussed with respect to FIG. 2, any of a variety of systems and/or processes may be utilized in accordance with embodiments of the disclosure. For example, the AP may transmit the discovery frame using a predefined transmission signal power in a first discovery cycle. Once the discovery cycle ends, the AP can re-transmit the discovery frame using an increased transmission signal power in a second discovery cycle. Thus, in every subsequent discovery cycle, the AP may perform a step wise increment on the transmission signal power to expand a discovery range of the AP. Such control on transmission signal power may reduce the chances of response collision in each discovery cycle iteration. The AP may continue re-transmitting the same discovery frame till the maximum transmission signal power is reached. Subsequently, the AP may generate new bitmasks and a new discovery frame and repeat the process. The elements depicted in FIG. 2 may also be interchangeable with other elements of FIGS. 1 and 3-9 as required to realize a particularly desired embodiment.

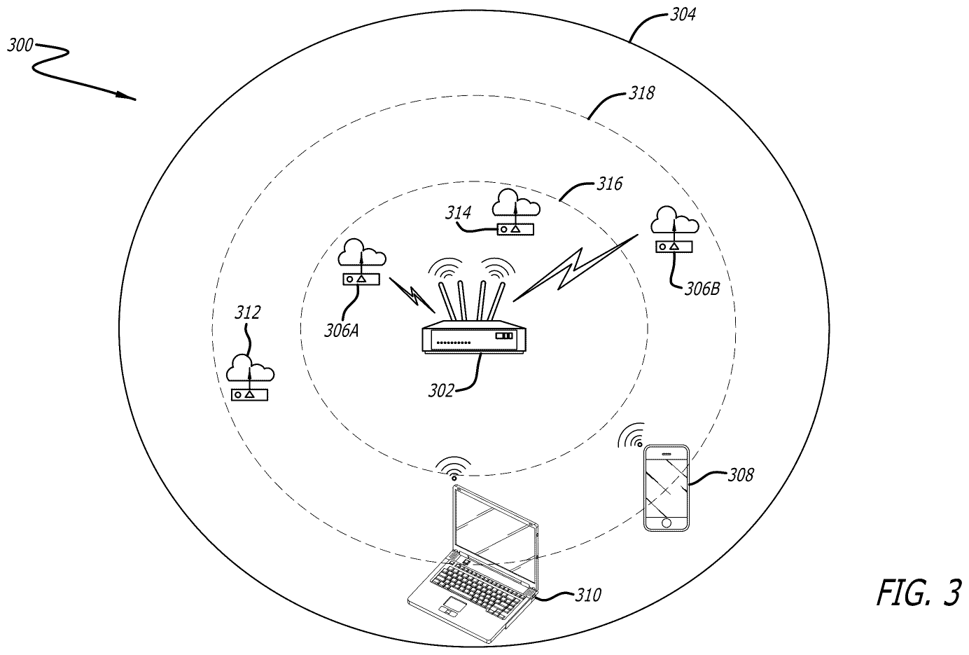

Referring to FIG. 3, an example diagram 300 that illustrates an example scenario of progressively increasing AP transmission power in each device discovery cycle in accordance with various embodiments of the disclosure is shown. The embodiments shown in FIG. 3 may illustrate a scenario where an AP 302 is utilizing a device discovery logic to discover nearby AMP devices. In the embodiment depicted in FIG. 3, a maximum communication range of the AP 302 is depicted by a circle 304. As shown in FIG. 3, the AP 302 may be already connected with AMP devices 306A, 306B. The AMP devices 306A, 306B may have been discovered and onboarded in previous discovery cycles by the AP 302. In order to discover and onboard other AMP devices 312, 314 located within the reach of the AP 302, the AP 302 may initiate a first discovery cycle.

In many embodiments, in the first discovery cycle, the AP 302 may generate a first discovery frame including one or more first bitmasks. Instead of transmitting the first discovery frame using the maximum transmission power, the AP 302 may adopt an approach in which signal transmission power is progressively increased in every subsequent discovery cycle to reduce response collisions. Thus, in the first discovery cycle, the AP 302 may transmit the first discovery frame using a first transmission power which is less than the maximum transmission power. An area enclosed within a dotted circle 316 may represent a first discovery range associated with the first transmission power. Any device (AMP or non-AMP) located within the first discovery range can receive the first discovery frame. For example, the AMP devices 306A and 314, located within the first discovery range, may receive the first discovery frame.

In a number of embodiments, any AMP device that is already associated with the AP 302 may discard the first discovery frame. Thus, the AMP device 306A, which is already associated with the AP 302 discards the first discovery frame. However, the AMP device 314, which is not associated with the AP 302, may receive the first discovery frame and determine whether a device identifier of the AMP device 314 matches any of the one or more first bitmasks. If a match is found, the AMP device 314 may transmit a response to the AP 302 in a response slot assigned for the matching bitmask. However, if no match is found, the AMP device 314 may discard the first discovery frame. In a non-limiting example, it is assumed that the AMP device 314 responds to the first discovery frame and gets associated with the AP 302.

In a variety of embodiments, the AP 302 may discover those AMP devices that responded to the first discovery frame in corresponding response slots. Once an epoch duration for the first discovery cycle ends, the AP 302 can initiate a second discovery cycle either immediately or after some set time interval. In the second discovery cycle, the AP 302 may retransmit the first discovery frame using a second transmission power which is greater than the first transmission power but less than the maximum transmission power. An area enclosed within a dotted circle 318 may represent a second discovery range associated with the second transmission power. Any device (AMP or non-AMP) located within the second discovery range can receive the first discovery frame. For example, the AMP devices 306A, 306B, 312, 314, located within the second discovery range, may receive the retransmitted first discovery frame.

Since the AMP devices 306A, 306B, 314 are already associated with the AP 302, the AMP devices 306A, 306B, 314 may discard the first discovery frame. However, the AMP device 312, which is not associated with the AP 302, may receive the first discovery frame and determine whether a device identifier of the AMP device 312 matches any of the one or more first bitmasks. If a match is found, the AMP device 312 may transmit a response to the AP 302 in a response slot assigned for the matching bitmask. However, if no match is found, the AMP device 312 may discard the first discovery frame. In a non-limiting example, it is assumed that the AMP device 312 does not respond to the first discovery frame due to a mismatch with the one or more first bitmasks.

In more embodiments, the AP 302 may discover those AMP devices that responded to the first discovery frame and may initiate a third discovery cycle either immediately or after some set time interval. In the third discovery cycle, the AP 302 may retransmit the first discovery frame using the maximum transmission power. Any device (AMP or non-AMP) located within the maximum communication range (depicted by the circle 304) can receive the first discovery frame. For example, the AMP devices 306A, 306B, 312, 314, a laptop 310, and a mobile phone 308, located within the maximum communication range, may receive the retransmitted first discovery frame. The AMP devices 306A, 306B, 314 are already onboarded, the AMP devices 306A, 306B, 314 may reject the first discovery frame. Similarly, the laptop 310 and the mobile phone 308 may also reject the first discovery frame. Further, the AMP device 312 having the device identifier that did not match any of the one or more first bitmasks may also reject the first discovery frame.

In response to absence of at least one new response at the maximum transmission power, the AP 302 may identify one or more second bitmasks that are different from the one or more first bitmasks and generate a second discovery frame including the one or more second bitmasks. The AP 302 may then transmit the second discovery frame with progressively increasing transmission power in each subsequent discovery cycle. The AP may continue this process until all AMP devices within the reach of the AP 302 are discovered and onboarded.

Although a specific embodiment for illustrating an example scenario of progressively increasing AP transmission power in each device discovery cycle suitable for carrying out the various steps, processes, methods, and operations described herein is discussed with respect to FIG. 3, any of a variety of systems and/or processes may be utilized in accordance with embodiments of the disclosure. For example, device identifiers of the AMP devices 312, 314 may match the same bitmask in the first discovery frame. Thus, if the AP 302 transmits the first discovery frame directly at the second transmission signal power without transmitting the first discovery frame at the first transmission signal power, the responses of the AMP devices 312, 314 may collide. In such a scenario, the AP 302 may refine the matching bitmask to identify narrower bitmasks which can discover the AMP devices 312, 314 separately. The AP 302 may then generate a new discovery frame including the narrower bitmasks and transmit the new discovery frame at the second transmission power in a new discovery cycle. The elements depicted in FIG. 3 may also be interchangeable with other elements of FIGS. 1, 2, and 4-10 as required to realize a particularly desired embodiment.

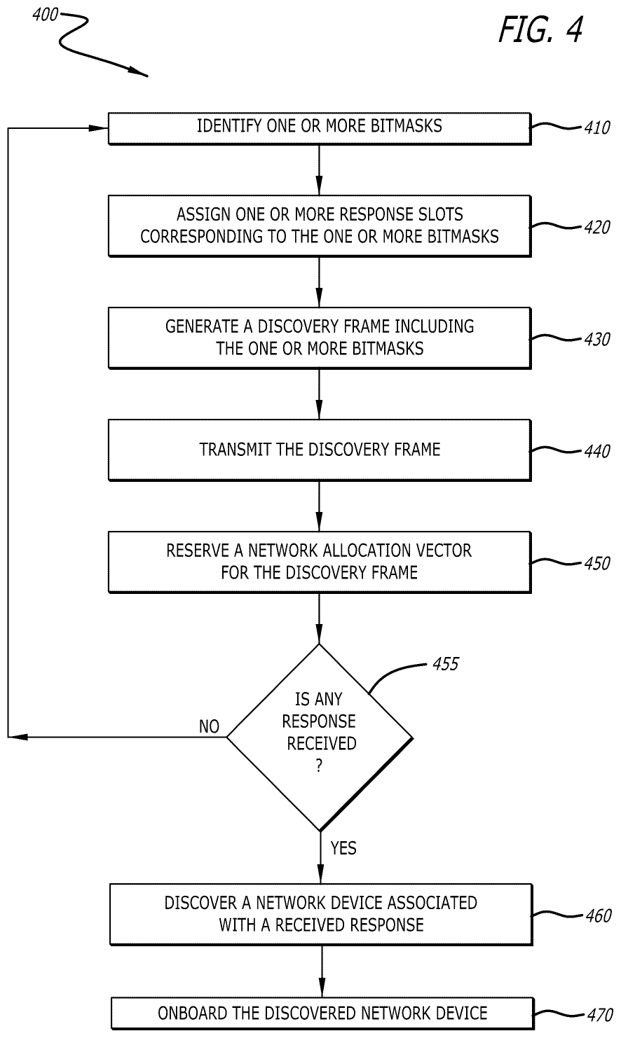

Referring to FIG. 4, a flowchart showing a process 400 for discovering and onboarding a network device by an AP in accordance with various embodiments of the disclosure is shown. In many embodiments, the process 400 may identify one or more bitmasks (block 410). In various embodiments, a bitmask can be identified by applying adaptive mask optimization, machine learning algorithms, or the like. In various additional embodiments, the process 400 may evaluate device identifiers of already onboarded network devices (e.g., AMP devices), determine repeating patterns (e.g., vendor information, type of network devices, or the like), and identify the one or more bitmasks based on the identified patterns. For example, the process 400 may determine that an onboarded Device A has OUI as “ABC”. The process 400 may then identify at least one bitmask based on the OUI “ABC”. A bitmask may be an identifier mask that a network device can apply to its unique device identifier.

In a number of embodiments, the process 400 may assign one or more response slots corresponding to the one or more bitmasks (block 420). In further embodiments, a response slot may refer to a time-bound period assigned for receiving a response associated with a corresponding bitmask. In further additional embodiments, consecutive response slots can be separated by set time interval, for example, SIFS. SIFS may provide a short buffer interval to ensure clear separation between responses received within the assigned response slots. In more embodiments, the process 400 may specify a response slot duration for each response slot.

In several embodiments, the process 400 may generate a discovery frame comprising the one or more bitmasks (block 430). In a variety of embodiments, the one or more bitmasks may be included (or listed) in a defined order within the discovery frame. The discovery frame may conform to a message format that is compatible with both AMP and non-AMP devices. In several more embodiments, the response slots for the one or more bitmasks can be assigned in the same defined order in which the one or more bitmasks are listed within the discovery frame. In some more embodiments, the process 400 may further specify a response slot duration for each response slot and an epoch duration in the discovery frame. In yet more embodiments, apart from the one or more bitmasks, the discovery frame may further include an SSID, one or more supported standards, a plurality of security settings, or the like.

In yet additional embodiments, the process 400 may transmit the discovery frame (block 440). In still yet additional embodiments, the process 400 may broadcast the discovery frame. In yet further embodiments, the process 400 can transmit one or more beamformed signals carrying the discovery frame. In still yet further embodiments, for enhanced precision, the process 400 may utilize directional discovery mechanisms such as sweeping a localized beam of transmission power, phased array steering, or the like, to narrowcast the discovery frame.

In many additional embodiments, the process 400 may reserve a network allocation vector (NAV) for the discovery frame (block 450). The NAV may be reserved for the epoch duration of the discovery frame, ensuring orderly and efficient communication within the allocated time period. The NAV may refer to a virtual carrier sensing mechanism utilized in wireless networks to indicate a duration for which a communication medium is reserved. By reserving the NAV for the epoch duration, the process 400 may ensure that no other device attempts to communicate with the AP or accesses a frequency channel used by the AP during the device discovery cycle.

In still yet more embodiments, the process 400 may determine whether any response is received (block 455). For example, the process 400 may scan the frequency channel during the assigned response slots to check if any network device has transmitted a response for the discovery frame. In still more embodiments, presence of a response in any of the response slots may indicate that at least one network device had a device identifier that matched one of the bitmasks included in the discovery frame. However, absence of any response may indicate that no network device matched the bitmasks included in the discovery frame.

In many further embodiments, if at least one response is received, the process 400 may discover a network device associated with the received response (block 460). For example, the network device may compare a corresponding device identifier with the bitmasks in the discovery frame and generate a response based on a match between the device identifier and one of the bitmasks. In still further embodiments, the process 400 may receive the response in a response slot that is assigned for the bitmask matching the device identifier. The process 400 may discover the network device in response to (or based on) receiving the response in the response slot. Examples of the network device may include an ambient power device.

In still additional embodiments, the process 400 may onboard the discovered network device (block 470). In one instance, when the AP onboards the network device, the AP manages device configuration, firmware, control transactions, and data transactions. In numerous embodiments, the process 400 may onboard the network device after successful authentication, authorization, and configuration of the network device.

However, in numerous additional embodiments, if no response is received, the process 400 may again identify one or more new bitmasks to discover network devices. The one or more new bitmasks may be different from the one or more bitmasks. For example, a new bitmask can be broader than an old bitmask. For example, one of the previous bitmasks can be “ABC-fffff0” and a new bitmask can be “ABC-ffffff” which is broader than the previous bitmask.

Although a specific embodiment for onboarding a network device suitable for carrying out the various steps, processes, methods, and operations described herein is discussed with respect to FIG. 4, any of a variety of systems and/or processes may be utilized in accordance with embodiments of the disclosure. For example, two or more responses may be received in a single response slot indicating identifiers of two or more devices match the same bitmask. In response to detecting a response collision, new bitmasks can be identified based on the bitmask that matched multiple device identifiers simultaneously. For example, the new bitmasks can be narrowed down versions of the same bitmask. The elements depicted in FIG. 4 may also be interchangeable with other elements of FIGS. 1-3 and 5-10 as required to realize a particularly desired embodiment.

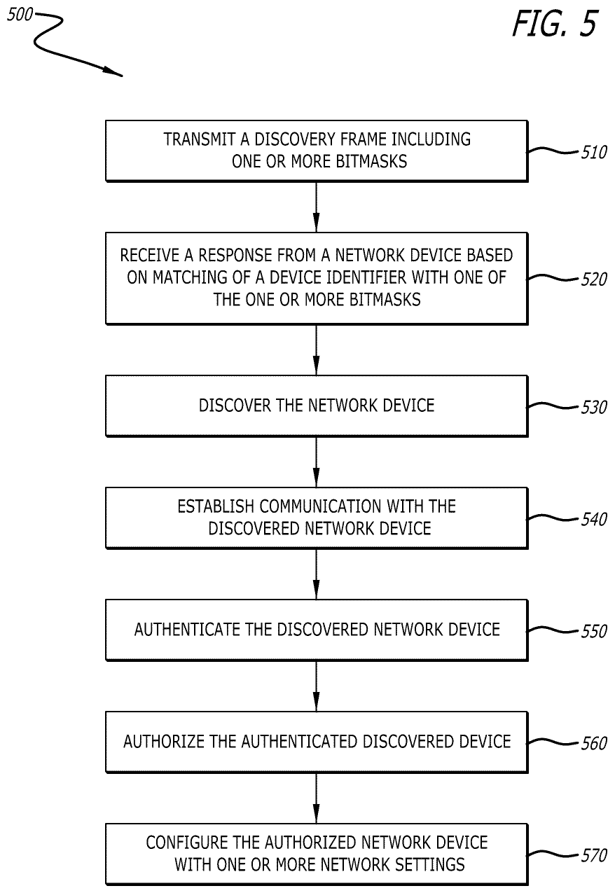

Referring to FIG. 5, a flowchart showing a process 500 for discovering and onboarding a network device by an AP in accordance with various embodiments of the disclosure. In many embodiments, the process 500 may transmit a discovery frame including one or more bitmasks (block 510). For example, the one or more bitmasks may be utilized to identify specific device identifiers, such as MAC addresses or other unique identifiers. In a number of embodiments, the process 500 may broadcast the discovery frame. In a variety of embodiments, the process 500 can transmit one or more beamformed signals carrying the discovery frame. In more embodiments, for enhanced precision, the process 500 may utilize directional discovery mechanisms such as sweeping a localized beam of transmission power, phased array steering, or the like, to narrowcast the discovery frame. The process 500 may further assign one or more response slots corresponding to the one or more bitmasks. The inclusion of the bitmasks in the discovery frame allows effective filtering of non-relevant devices and ensures that only those devices that meet specific bitmask patterns are considered for onboarding.

In various embodiments, the process 500 may receive a response from a network device based on matching of a device identifier with one of the one or more bitmasks (block 520). In further embodiments, the process 500, after transmitting the discovery frame, may wait to receive responses from network devices. For example, the network device whose device identifier matches one of the bitmasks in the discovery frame may transmit a response. The response may indicate that the device's identifier aligns with the bitmask criteria, signaling its presence and readiness to engage in further communication.

In additional embodiments, the process 500 may discover the network device (block 530). In still further embodiments, the process 500 may verify that the device identifier of the network device actually matches with one of the bitmasks included in the discovery frame. The process 500 may confirm the existence and eligibility of the network device to join the network. Discovering the network device is required to recognizing new or returning devices that need to be managed by the AP, setting the stage for further interaction, including authentication and configuration.

In yet more embodiments, the process 500 may establish communication with the discovered network device (block 540). In still yet more embodiments, the process 500 may initiate a connection using the device identifier of the network device and ensure that both the AP and the network device can exchange data effectively. Establishing communication can enable subsequent processes, such as authentication and configuration, to take place. It ensures that the network device is properly integrated into the network, and ready for further interaction and management.

In many additional embodiments, the process 500 may authenticate the discovered network device (block 550). The process 500 may verify the identity of the discovered network device to ensure that the network device is legitimate and can join the network. This typically involves checking credentials, such as passwords or digital certificates. Successful authentication may ensure that the network device is not a malicious entity, providing a layer of security to protect the network from potential threats.

In yet further embodiments, the process 500 may authorize the authenticated discovered device (block 560). Authorization determines what level of access the network device will have within the network. The process 500 may assign permissions and restrictions based on predefined policies, ensuring that the network device can only access resources and perform actions it is permitted to. Authorization is an important operation required for maintaining network security and integrity, as it controls the interaction of the network device with network resources.

In still yet additional embodiments, the process 500 may configure the authorized network device with one or more network settings (block 570). For example, the process 500 may include assigning an Internet Protocol (IP) address, setting up network protocols, and configuring security settings. Proper configuration ensures that the network device can function correctly and efficiently within the network, adhering to the network's policies and requirements. Successful configuration completes the onboarding process of the network device, enabling the device to operate seamlessly within the network environment.

Although a specific embodiment for a process 500 for configuring an onboarded network device suitable for carrying out the various steps, processes, methods, and operations described herein is discussed with respect to FIG. 5, any of a variety of systems and/or processes may be utilized in accordance with embodiments of the disclosure. For example, in absence of a response, a new discovery frame with new bitmasks can be transmitted at a higher or lower transmission power to discover one or more network devices. Further, once a network device is onboarded, the AP can poll the onboarded network device as and when information is required or at periodic intervals. The elements depicted in FIG. 5 may also be interchangeable with other elements of FIGS. 1-4 and 6-10 as required to realize a particularly desired embodiment.

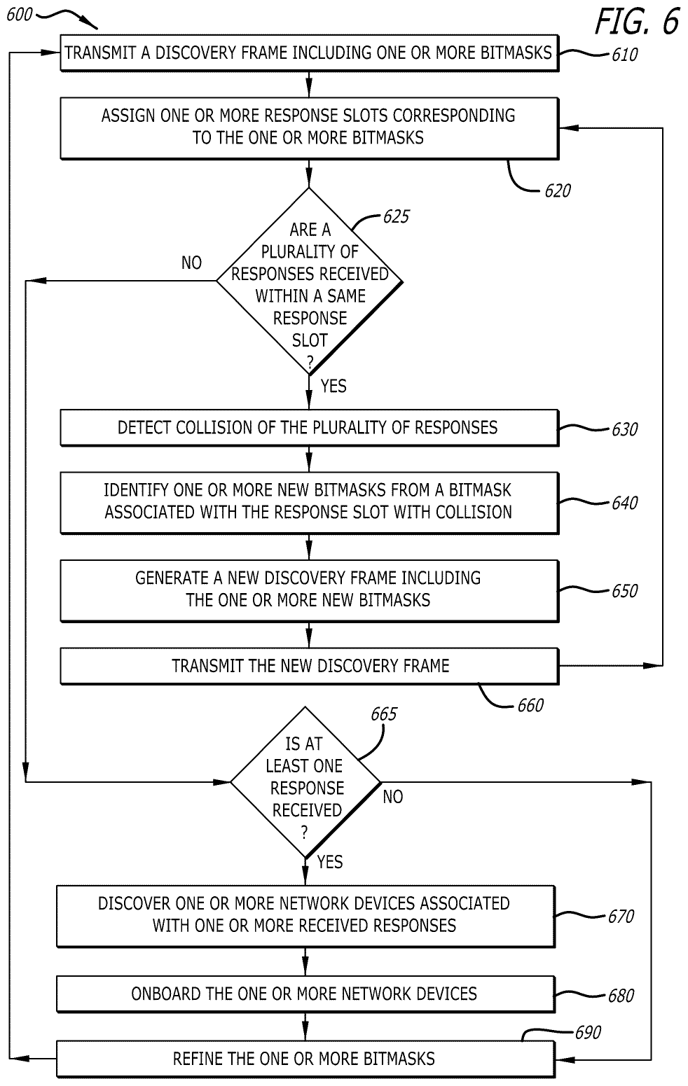

Referring to FIG. 6, a flowchart showing a process 600 for discovery of one or more network devices with similar identifiers in accordance with various embodiments of the disclosure. In many embodiments, the process 600 may transmit a discovery frame including one or more bitmasks (block 610). For example, the process 600 may identify a bitmask “00:1A:2B-ffffff” to discover network devices from a particular vendor having “00:1A:2B” as OUI.

In a number of embodiments, the process 600 may assign one or more response slots corresponding to the one or more bitmask (block 620). In further embodiments, a response slot may refer to a time-bound period assigned for receiving a response associated with a corresponding bitmask, thus allowing the process 600 to discover network devices. In further additional embodiments, consecutive response slots can be separated by set time interval, for example, SIFS. SIFS may provide a short buffer interval to ensure clear separation between responses received within the assigned response slots. In more embodiments, the process 500 may specify a response slot duration for each response slot.

In a variety of embodiments, the process 600 may determine whether a plurality of responses are received within the same response slot (block 625). Receiving multiple responses within the same response slot may indicate that there are multiple network devices within the reach of the AP that matched with the same bitmask. Thus, signifying a degree of similarity in their device identifiers. For example, two network devices with MAC addresses “00:1A:2B-00:11:22” and “00:1A:2B-33:44:55” may respond to the same bitmask “00:1A:2B-ffffff” within the same response slot. In various embodiments, if a plurality of responses are received within the same response slot, the process 600 may detect a collision of the plurality of responses (block 630).

In additional embodiments, the process 600 may identify one or more new bitmasks from the bitmask associated with the response slot with collision (block 640). In other words, the process 600 may refine (e.g., narrow down) the bitmask that caused the collision to create more specific bitmasks. For example, the original bitmask “00:1A:2B-ffffff” can be narrowed down to two new bitmasks “00:1A:2B-0000ff” and “00:1A:2B-00ff00” to differentiate the network devices causing the collision.

In further additional embodiments, the process 600 may generate a new discovery frame including the one or more new bitmasks (block 650). In other words, the process 600 may generate the new discovery frame with the new bitmasks to ensure spaced apart responses from the two or more network devices causing the collision. The process 600 can generate the new discovery frame during the same discovery cycle or during a different discovery cycle.

In several embodiments, the process 600 may transmit the new discovery frame (block 660). In still additional embodiments, the process 600 may further reassign one or more response slots for the new bitmasks included in the new discovery frame (block 620). For example, the process 600 may transmit the new discovery frame and wait for responses in the reassigned response slots and the discovery process continues.

In further embodiments, if multiple responses are not received within the same response slot, the process 600 may determine if at least one response is received (block 665). If at least one response is received, in several more embodiments, the process 600 may discover one or more network devices associated with one or more received responses (block 670). In other words, the process 600 may identify and discover the network devices based on the responses received. For example, if the process 600 successfully receives a single response in a response slot, the process 600 may discover the responding network device.

In several more embodiments, the process 600 may onboard the one or more network devices (block 680). The process 600 may further establish communication with the one or more network devices and configure them for network use. For example, the process 600 can authenticate and authorize the network devices, and then configure the network devices with network settings.

However, if no responses are received, in many further embodiments, the process 600 may refine the one or more bitmasks (block 690). The process 600 may refine the one or more bitmasks to improve the discovery process and generate a new discovery frame including the refined bitmasks. For example, if no device responds, the process 600 adjusts the bitmasks to broaden the scope and retries the discovery process. The process may then transmit the new discover frame and repeat the process (block 610).

Although a specific embodiment for discovery of one or more network devices with similar bitmasks suitable for carrying out the various steps, processes, methods, and operations described herein is discussed with respect to FIG. 6, any of a variety of systems and/or processes may be utilized in accordance with embodiments of the disclosure. For example, in many additional embodiments, prior to transmitting the discovery frame, one or more RF signals can be transmitted to energize nearby network device when the network devices are AMP devices. The elements depicted in FIG. 6 may also be interchangeable with other elements of FIGS. 1-5 and 7-10 as required to realize a particularly desired embodiment.

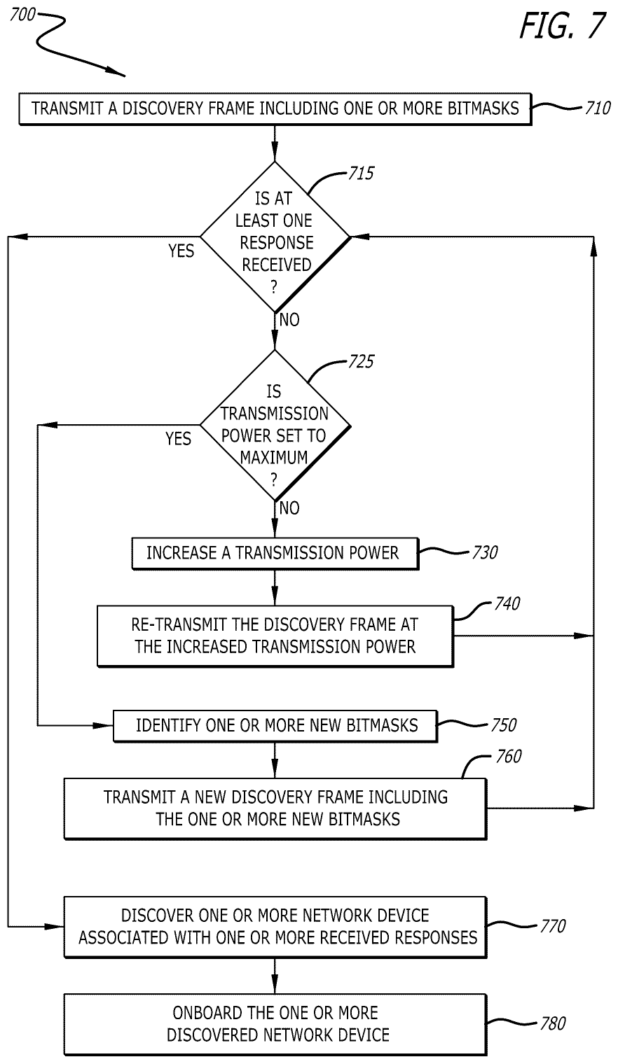

Referring to FIG. 7, a flowchart showing a process 700 for transmitting a discovery frame by dynamically adjusting transmission power, in accordance with various embodiments of the disclosure is shown. In a number of embodiments, the process 700 may transmit a discovery frame including one or more bitmasks (block 710). In numerous embodiments, the discovery frame can be transmitted at a predefined transmission power. For example, the process 700 may transmit the discovery frame with the one or more bitmasks targeting devices within a particular discovery range.

In many embodiments, the process 700 may determine whether at least one response is received (block 715). For example, the process 700 may scan a reserved frequency channel during an epoch duration associated with the discovery frame to determine if any response is received. The frequency channel can be reserved using a NAV.

If no response is received, in numerous embodiments, the process 700 may determine whether a transmission power is set to maximum (block 725). In other words, the process 700 may check if the current transmission power is set to the maximum transmission power or not. The process 700 may perform this check to ascertain whether there is a possibility to extend the discovery range.

If the transmission power is not set to maximum, in various embodiments, the process 700 may increase the transmission power (block 730). The increase in transmission power may be aimed at extending the discovery range, allowing the discovery frame to reach more distant network devices that might not have responded at lower transmission power. As a result, more devices in the network may be discovered.

In numerous embodiments, the process 700 may re-transmit the discovery frame at the increased transmission power (block 740). In other words, the process 700 may transmit the discovery frame again at the increased transmission power. This enhanced transmission aims to reach network devices that were previously out of range. The process 700 may then return to check for responses (block 715).

In more embodiments, if the transmission power is already set to the maximum, the process 700 may identify one or more new bitmasks (block 750). In yet more embodiments, the process 700 may generate a new discovery frame including the one or more new bitmasks. The new bitmasks may be identified to target a different set of device identifiers or configurations.

In numerous embodiments, the process 700 may transmit the new discovery frame including the one or more new bitmasks (block 760). In other words, the process 700 may broadcast, narrowcast, or beamform the new discovery frame containing the new bitmasks. The new discovery frame may reach one or more network devices, possibly those that did not respond to the initial bitmasks. The process 700 may then loop back to wait for responses from one or more network devices for the new discovery frame (block 715).

However, if at least one response is received, in several embodiments, the process 700 may discover one or more network devices associated with one or more received responses (block 770). In many further embodiments, the process 700 may discover the one or more network devices based on the one or more received responses.

In numerous additional embodiments, the process 700 may onboard the one or more discovered network devices (block 780). In other words, the process 700 may onboard the discovered network devices after performing various operations such as authentication, authorization, and configuration. For example, the process 700 may assign network settings, ensure the discovered network devices are secure, and integrate them into the network for operational use.

Although a specific embodiment for transmitting a discovery frame by dynamically adjusting a transmission power suitable for carrying out the various steps, processes, methods, and operations described herein is discussed with respect to FIG. 7, any of a variety of systems and/or processes may be utilized in accordance with embodiments of the disclosure. For example, in still further embodiments, the process 700 may increase the transmission power in predefined steps in each subsequent discovery cycle. The elements depicted in FIG. 6 may also be interchangeable with other elements of FIGS. 1-6 and 8-10 as required to realize a particularly desired embodiment.

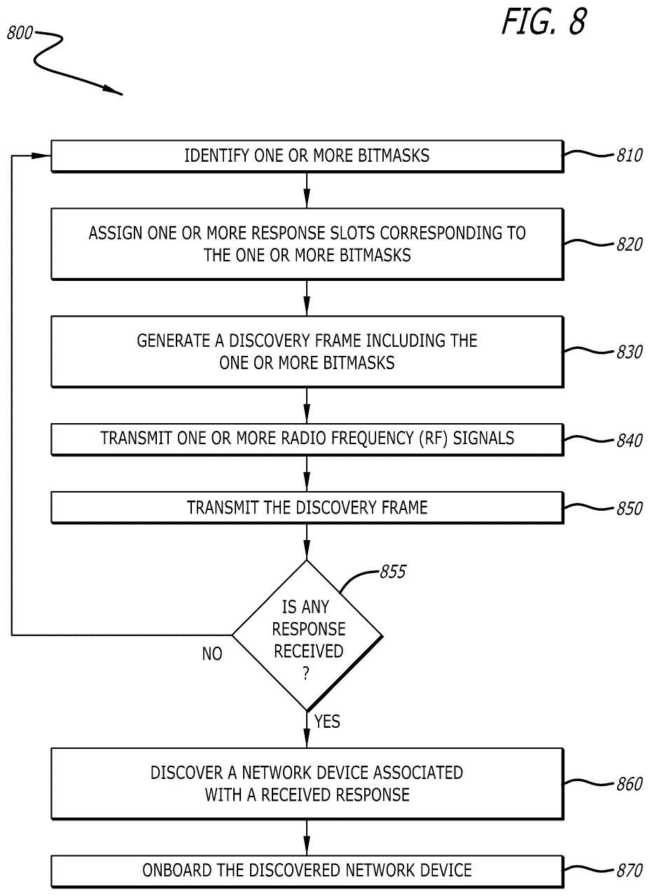

Referring to FIG. 8, a flowchart showing a process 800 for onboarding one or more AMP devices by an AP in accordance with various embodiments of the disclosure is shown. In many embodiments, the process 800 may identify one or more bitmasks (block 810). In numerous embodiments, the one or more bitmasks may be predefined patterns utilized to identify specific device identifiers (e.g., MAC addresses). For example, the process 800 may want to discover AMP devices from a specific vendor. Thus, the process 800 may use a bitmask like OUI-ffffff to discover all AMP devices from that vendor. In more examples, the bitmask OUI-fffff0 could be used to discover AMP devices from a specific vendor and whose identifiers have a specific pattern in the least significant bit. The one or more bitmasks can thus help in filtering AMP devices during discovery cycle, ensuring that only relevant AMP devices respond.

In a number of embodiments, the process 800 may assign one or more response slots corresponding to the one or more bitmasks (block 820). In numerous additional embodiments, each response slot is allocated a specific duration, indicating when AMP devices matching the respective bitmask should respond. For example, the process 800 may allocate a first response slot to devices matching the bitmask OUI-ffffff and a second response slot to devices matching the bitmask OUI-fffff0. Each response slot is given a specific duration (e.g., 100 milliseconds) during which the devices matching the corresponding bitmask should respond. This may prevent response collisions and organize the communication process.

In more embodiments, the process 800 may generate a discovery frame including the one or more bitmasks (block 830). The discovery frame may further include instructions for the AMP devices on when and how to respond. For example, the discovery frame may include instructions for the AMP devices matching the bitmask OUI-ffffff to respond in the first response slot and the AMP devices matching the bitmask OUI-fffff0 to respond in the second response slot. The discovery frame thus serves as a beacon, broadcasting readiness of the AP to identify and onboard new AMP devices.

In further embodiments, the process 800 may transmit one or more RF signals (block 840). In several embodiments, the RF signals can energize AMP devices within the communication range of the AP, enabling the AMP devices to respond to the discovery frame even if they lack traditional power sources. For example, in a smart office environment, the RF signals may energize battery-free sensors like temperature sensors and motion detectors.

In further additional embodiments, the process 800 may transmit the discovery frame (block 850). The process 800 may broadcast the discovery frame, for example, by utilizing a phased array of transmission power. For example, the discovery frame, including the bitmasks and the response slot details, may invite a plurality of devices (e.g. smart badges, environmental sensors, security cameras, or the like) to respond if their device identifiers match any of the included bitmasks.

In still yet additional embodiments, the process 800 may determine whether any response is received (block 855). For example, the process 800 may scan the frequency channel during the assigned response slots to check if any AMP device has transmitted a response for the discovery frame. In still more embodiments, presence of a response in any of the response slots may indicate that at least one AMP device had a device identifier that matched one of the bitmasks included in the discovery frame. However, absence of any response may indicate that no AMP device matched the bitmasks included in the discovery frame

In further additional embodiments, if the response is received, the process 800 may discover a network device associated with the received response (block 860). For example, if an identifier of an AMP device matches the bitmask OUI-ffffff included in the discovery frame, the process 800 may recognize the AMP device as a valid network device. This discovery confirms the presence and eligibility of the network device for onboarding.

In several embodiments, the process 800 may onboard the discovered network device (block 870). For example, once the process 800 has discovered the AMP device, the process 800 may further establish communication, authenticate the AMP device by verifying its credentials, authorize the AMP device to ensure that the AMP device has appropriate access, and configure the AMP device with network settings like assigning the AMP device an IP address. This comprehensive onboarding process ensures the AMP device is fully integrated and operational within the network.

Although a specific embodiment for onboarding one or more AMP STAs suitable for carrying out the various steps, processes, methods, and operations described herein is discussed with respect to FIG. 8, any of a variety of systems and/or processes may be utilized in accordance with embodiments of the disclosure. For example, in still yet further embodiments, the process 800 may use directional sweeping of a localized beam of RF signal to narrowcast the discovery frame. The elements depicted in FIG. 8 may also be interchangeable with other elements of FIGS. 1-7 and FIGS. 9-10 as required to realize a particularly desired embodiment.

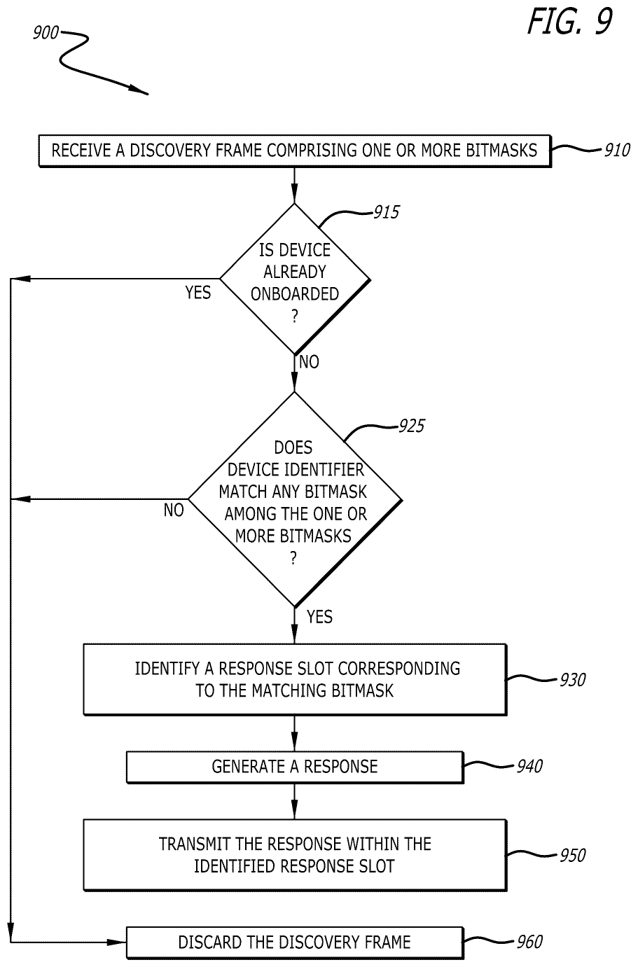

Referring to FIG. 9, a flowchart showing a process 900 for responding to a discovery frame by a network device in accordance with various embodiments of the disclosure is shown. In many embodiments, the process 900 may receive a discovery frame comprising one or more bitmasks (block 910). In numerous embodiments, the one or more bitmasks may be configured to discover network devices with certain device identifiers in the network. For example, if network devices have MAC addresses as an identifier, a bitmask such as OUI-ffffff can be used to discover network devices from a specific vendor. In another example, if all fire alarm sensors from vendor A have a serial number format such as Fn986-8digits. A bitmask Fn986-ffffffff can be used in the discovery frame to discover any fire alarm sensor from the vendor A.

In various embodiments, upon receiving the discovery frame, the process 900 may determine whether the device is already onboarded (block 915). For example, the process 900 may verify the network settings to confirm if the device is onboarded with an AP that had transmitted the discovery frame. The network settings may indicate an identifier of the AP to which the device is connected. The process 900 may check if the discovery frame also includes the same identifier.

In numerous additional embodiments, if the device is not onboarded, the process 900 may determine whether a device identifier matches any bitmask among the one or more bitmasks (block 925). In more embodiments, to determine whether the device identifier matches any of the bitmasks in the discovery frame, the process 900 may compare the device identifier with the bitmasks.

In still more embodiments, if the device identifier matches one of the bitmasks, the process 900 may identify a response slot corresponding to the matching bitmask (block 930). In still yet more embodiments, a response slot for a bitmask is assigned in the same defined order in which the one or more bitmasks are listed within the discovery frame. Thus, depending on a position of the matching bitmask within the discovery frame, the process 900 may identify the response slot.

In several embodiments, the process 900 may generate a response (block 940). The response may include necessary information confirming the presence and readiness of the device for onboarding. For example, the process 900 may prepare a response frame including the device identifier and other relevant data, for example, supported protocols, vendor details, or the like.

In further embodiments, the process 900 may transmit the response within the identified response slot (block 950). For example, once the response slot is identified, the process 900 may wait for a number of ticks associated with the identified response slot and then transmit the response within the response slot. In some more embodiments, the process 900 may wait for a number of ticks associated with the identified response slot. The tick speed along with an epoch duration may be indicated in the discovery frame. In several additional embodiments, the process 900 may determine the wait period based on the result of a tick count modulo epoch duration.

In a number of embodiments, if the device is already onboarded or the device identifier does not match any bitmask, the process 900 may discard the discovery frame (block 960). For example, a sensor that has already been configured in the network may recognize the onboarded status and discard the discovery frame. In more examples, a smart light bulb whose device identifier does not match any of the bitmasks may ignore the discovery frame, preventing unnecessary processing.

Although a specific embodiment for responding to a discovery frame received by one or more network devices suitable for carrying out the various steps, processes, methods, and operations described herein is discussed with respect to FIG. 9, any of a variety of systems and/or processes may be utilized in accordance with embodiments of the disclosure. For example, in still yet further embodiments, a device with unknown identifiers may receive a discovery frame with a broad set of bitmasks. The device may thus respond in a response slot assigned to the broad set of bitmasks. The elements depicted in FIG. 9 may also be interchangeable with other elements of FIGS. 1-8 and FIG. 10 as required to realize a particularly desired embodiment.

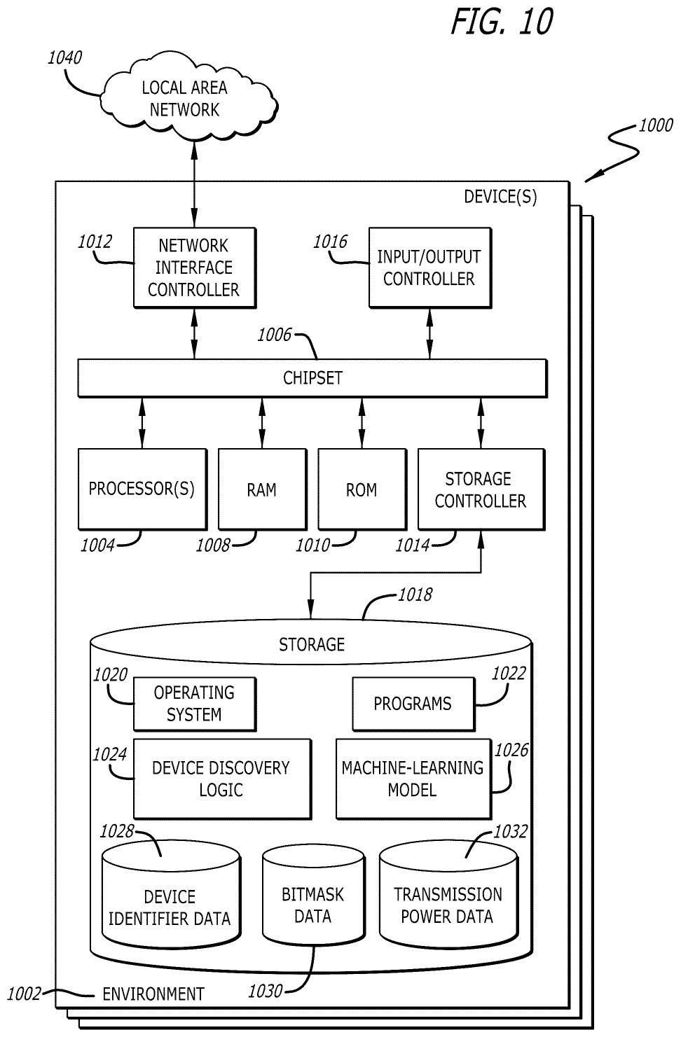

Referring to FIG. 10, a conceptual block diagram of a device 1000 suitable for configuration with a device discovery logic, in accordance with various embodiments of the disclosure is shown. The embodiment of the conceptual block diagram depicted in FIG. 10 can illustrate a conventional server, computer, workstation, desktop computer, laptop, tablet, network appliance, e-reader, smartphone, or other computing device, and can be utilized to execute any of the application and/or logic components presented herein. The embodiment of the conceptual block diagram depicted in FIG. 10 can also illustrate an access point, a switch, or a router in accordance with various embodiments of the disclosure. The device 1000 may, in many nonlimiting examples, correspond to physical devices or virtual resources described herein.

In many embodiments, the device 1000 may include an environment 1002 such as a baseboard or “motherboard,” in physical embodiments that can be configured as a printed circuit board with a multitude of components or devices connected by way of a system bus or other electrical communication paths. Conceptually, in virtualized embodiments, the environment 1002 may be a virtual environment that encompasses and executes the remaining components and resources of the device 1000. In more embodiments, one or more processors 1004, such as, but not limited to, central processing units (“CPUs”) can be configured to operate in conjunction with a chipset 1006. The processor(s) 1004 can be standard programmable CPUs that perform arithmetic and logical operations necessary for the operation of the device 1000.

In a number of embodiments, the processor(s) 1004 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In various embodiments, the chipset 1006 may provide an interface between the processor(s) 1004 and the remainder of the components and devices within the environment 1002. The chipset 1006 can provide an interface to a random-access memory (“RAM”) 1008, which can be used as the main memory in the device 1000 in some embodiments. The chipset 1006 can further be configured to provide an interface to a computer-readable storage medium such as a read-only memory (“ROM”) 1010 or non-volatile RAM (“NVRAM”) for storing basic routines that can help with various tasks such as, but not limited to, starting up the device 1000 and/or transferring information between the various components and devices. The ROM 1010 or NVRAM can also store other application components necessary for the operation of the device 1000 in accordance with various embodiments described herein.

Additional embodiments of the device 1000 can be configured to operate in a networked environment using logical connections to remote computing devices and computer systems through a network, such as the network 1040. The chipset 1006 can include functionality for providing network connectivity through a network interface card (“NIC”) 1012, which may comprise a gigabit Ethernet adapter or similar component. The NIC 1012 can be capable of connecting the device 1000 to other devices over the network 1040. It is contemplated that multiple NICs 1012 may be present in the device 1000, connecting the device to other types of networks and remote systems.

In further embodiments, the device 1000 can be connected to a storage 1018 that provides non-volatile storage for data accessible by the device 1000. The storage 1018 can, for instance, store an operating system 1020, applications 1022, device identifier data 1028, bitmask data 1030, and transmission power data 1032 which are described in greater detail below. The storage 1018 can be connected to the environment 1002 through a storage controller 1014 connected to the chipset 1006. In certain embodiments, the storage 1018 can consist of one or more physical storage units. The storage controller 1014 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The device 1000 can store data within the storage 1018 by transforming the physical state of the physical storage units to reflect the information being stored. The specific transformation of the physical state can depend on various factors. Examples of such factors can include, but are not limited to, the technology used to implement the physical storage units, whether the storage 1018 is characterized as primary or secondary storage, and the like.

In many more embodiments, the device 1000 can store information within the storage 1018 by issuing instructions through the storage controller 1014 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 1000 can further read or access information from the storage 1018 by detecting the physical states or characteristics of one or more particular locations within the physical storage units.

In addition to the storage 1018 described above, the device 1000 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 1000. In some examples, the operations performed by a cloud computing network, and or any components included therein, may be supported by one or more devices similar to device 1000. Stated otherwise, some or all of the operations performed by the cloud computing network, and or any components included therein, may be performed by one or more devices 1000 operating in a cloud-based arrangement. By way of example, and not limitation, computer-readable storage media can include volatile and non-volatile, removable and non-removable media implemented in any method or technology.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage 1018 can store an operating system 1020 utilized to control the operation of the device 1000. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage 1018 can store other system or application programs and data utilized by the device 1000.

In many additional embodiments, the storage 1018 or other computer-readable storage media is encoded with computer-executable instructions which, when loaded into the device 1000, may transform it from a general-purpose computing system into a special-purpose computer capable of implementing the embodiments described herein. These computer-executable instructions may be stored as application 1022 and transform the device 1000 by specifying how the processor(s) 1004 can transition between states, as described above. In some embodiments, the device 1000 has access to computer-readable storage media storing computer-executable instructions which, when executed by the device 1000, perform the various processes described above with regard to FIGS. 1-9. In certain embodiments, the device 1000 can also include computer-readable storage media having instructions stored thereupon for performing any of the other computer-implemented operations described herein.

In still further embodiments, the device 1000 can also include one or more input/output controllers 1016 for receiving and processing input from a number of input devices, such as a keyboard, a mouse, a touchpad, a touch screen, an electronic stylus, or other type of input device. Similarly, an input/output controller 1016 can be configured to provide output to a display, such as a computer monitor, a flat panel display, a digital projector, a printer, or other type of output device. Those skilled in the art will recognize that the device 1000 might not include all of the components shown in FIG. 10 and can include other components that are not explicitly shown in FIG. 10 or might utilize an architecture completely different than that shown in FIG. 10.

As described above, the device 1000 may support a virtualization layer, such as one or more virtual resources executing on the device 1000. In some examples, the virtualization layer may be supported by a hypervisor that provides one or more virtual machines running on the device 1000 to perform the functions described herein. The virtualization layer may generally support a virtual resource that performs at least a portion of the techniques described herein.

In many further embodiments, the device 1000 may include a device discovery logic 1024. The device discovery logic 1024 can be configured to perform one or more of the various steps, processes, operations, and/or other methods that are described above. Often, the device discovery logic 1024 can be a set of instructions stored within a non-volatile memory that, when executed by the processor(s)/controller(s) 1004 can carry out these steps, etc. In certain embodiments, the device discovery logic 1024 may perform various operations related to device discovery and onboarding. In some embodiments, the device 1000 can be an AP. In such embodiments, the device discovery logic 1024 may be configured to identify bitmasks, generate and transmit discovery frames, discover and onboard responding AMP devices, or the like. In some additional embodiments, the device 1000 can be an AMP device. In such embodiments, the device discovery logic 1024 may receive a discovery frame, compare a device identifier with various bitmasks included in the discovery frame, and transmit a response in a dedicated response slot if the device identifier matches a bitmask.

In various embodiments, the storage 1018 can include the device identifier data 1028. The device identifier data 1028 may include unique identifiers associated with the plurality of network devices that are already discovered and onboarded with the device 1000. The identifiers may include MAC addresses, serial numbers, or vendor specific numbers to identify one or more network devices. The device identifier data 1028 may be utilized by the device discovery logic 1024 to identify new bitmasks for device discovery process.

In still more embodiments, the storage 1018 can include the bitmask data 1030. The bitmask data 1030 may store a collection of bitmasks identified by the device discovery logic 1024 during device discovery cycles. In more embodiments, the device discovery logic 1024 may retrieve one or more bitmasks from the bitmask data 1030 and generate the discovery frame.

In a number of embodiments, the storage 1018 can include transmission power data 1032. The transmission power data 1032 may store transmission power level associated with a discovery range of the device 1000. Further, the transmission power data 1032 may vary based on the type of network. Thus, the device discovery logic 1024 may refer to the transmission power data 1032 to select transmission power for a current discovery cycle.

Finally, in numerous additional embodiments, data may be processed into a format usable by a machine-learning model 1026 (e.g., feature vectors), and or other pre-processing techniques. The machine-learning (“ML”) model 1026 may be any type of ML model, such as supervised models, reinforcement models, and/or unsupervised models. The ML model 1026 may include one or more of linear regression models, logistic regression models, decision trees, Naïve Bayes models, neural networks, k-means cluster models, random forest models, and/or other types of ML models 1026.

The ML model(s) 1026 can be configured to generate inferences to make predictions or draw conclusions from data. An inference can be considered the output of a process of applying a model to new data. This can occur by learning from at least the device identifier data 1028, the bitmask data 1030, and the transmission power data 1032, and utilizing the learning to predict future outcomes. For example, the ML model(s) 1026 can be trained to adjust or refine bitmasks. These predictions are based on patterns and relationships discovered within the data. To generate an inference, the trained model can take input data and produce a prediction or a decision. The input data can be in various forms, such as images, audio, text, or numerical data, depending on the type of problem the model was trained to solve. The output of the model can also vary depending on the problem, and can be a single number, a probability distribution, a set of labels, a decision about an action to take, etc. Ground truth for the ML model(s) 1026 may be generated by human/administrator verifications or may compare predicted outcomes with actual outcomes.

Although a specific embodiment for a device suitable for configuration with a dynamic proxying logic for carrying out the various steps, processes, methods, and operations described herein is discussed with respect to FIG. 10, any of a variety of systems and/or processes may be utilized in accordance with embodiments of the disclosure. For example, the device may be in a virtual environment such as a cloud-based network administration suite, or it may be distributed across a variety of network devices or switches. The elements depicted in FIG. 10 may also be interchangeable with other elements of FIGS. 1-9 as required to realize a particularly desired embodiment.

Although a specific embodiment for a conceptual block diagram of the device 1000 suitable for configuration with the device discovery logic suitable for carrying out the various steps, processes, methods, and operations described herein is discussed with respect to FIG. 10, any of a variety of systems and/or processes may be utilized in accordance with embodiments of the disclosure. For example, the device may be in a virtual environment such as a cloud-based network administration suite, or it may be distributed across a variety of network devices or switches. The elements depicted in FIG. 10 may also be interchangeable with other elements of FIGS. 1-9 as required to realize a particularly desired embodiment.

Although the present disclosure has been described in certain specific aspects, many additional modifications and variations would be apparent to those skilled in the art. In particular, any of the various processes described above can be performed in alternative sequences and/or in parallel (on the same or different computing devices) in order to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A device, comprising:
a processor;
a network interface controller configured to provide access to a network; and
a memory communicatively coupled to the processor, wherein the memory comprises a device discovery logic that is configured to:
identify one or more bitmasks;
generate a discovery frame including the one or more bitmasks;
transmit the discovery frame; and
discover a network device in response to transmitting the discovery frame, wherein the discovered network device has an identifier that matches a bitmask among the one or more bitmasks.

2. The device of claim 1, wherein the device discovery logic is further configured to assign a response slot for each of the one or more bitmasks.

3. The device of claim 2, wherein the one or more bitmasks are listed in a defined order within the discovery frame.

4. The device of claim 3, wherein the device discovery logic is further configured to assign the response slot for each of the one or more bitmasks in the defined order in which the one or more bitmasks are listed within the discovery frame.

5. The device of claim 2, wherein the device discovery logic is further configured to receive a response from the network device.

6. The device of claim 5, wherein the network device is discovered based on the received response.

7. The device of claim 5, wherein the response is received within the response slot assigned to the bitmask that matched the identifier of the network device.

8. The device of claim 2, wherein the device discovery logic is further configured to:
detect a collision of a plurality of responses in the response slot assigned to at least one other bitmask among the one or more bitmasks;
identify one or more new bitmasks based on the at least one other bitmask;
generate a first new discovery frame including the one or more new bitmasks; and
transmit the first new discovery frame.

9. The device of claim 8, wherein the device discovery logic is further configured to determine whether at least one new response is received for the first new discovery frame.

10. The device of claim 9, wherein in absence of the at least one new response, the device discovery logic is further configured to:
increase a signal transmission power; and
re-transmit the first new discovery frame with the increased signal transmission power.

11. The device of claim 9, wherein the device discovery logic is further configured to:
refine the one or more new bitmasks in absence of the at least one new response;
generate a second new discovery frame including the refined one or more new bitmasks; and
transmit the second new discovery frame.

12. The device of claim 1, wherein prior to transmitting the discovery frame, the device discovery logic is further configured to transmit one or more Radio Frequency (RF) signals, and wherein the one or more RF signals are configured to energize an ambient power device located within a communication range of the device.

13. The device of claim 12, wherein the network device is the ambient power device.

14. The device of claim 1, wherein transmitting the discovery frame comprises broadcasting the discovery frame.

15. The device of claim 1, wherein to transmit the discovery frame, the device discovery logic is further configured to transmit one or more beamformed signals carrying the discovery frame.

16. The device of claim 1, wherein the device discovery logic is further configured to indicate an epoch duration and a response slot duration along with the discovery frame, and wherein the epoch duration corresponds to a total amount of time allocated for receiving one or more responses to the discovery frame.

17. The device of claim 16, wherein the device discovery logic is further configured to reserve a network allocation vector (NAV) for the epoch duration.

18. A device, comprising:
a processor;
a network interface controller configured to provide access to a network; and
a memory communicatively coupled to the processor, wherein the memory comprises a device discovery logic that is configured to:
receive a discovery frame comprising one or more bitmasks;
compare the one or more bitmasks with a device identifier;
generate a response based on a match between the device identifier and a bitmask of the one or more bitmasks; and
transmit the response.

19. The device of claim 18, wherein the device discovery logic is further configured to identify a response slot associated with the bitmask that matched the device identifier, and wherein the response is transmitted within the response slot.

20. A method, comprising:
identifying one or more bitmasks;
generating a discovery frame including the one or more bitmasks;
transmitting the discovery frame; and
discovering a network device in response to transmitting the discovery frame, wherein the discovered network device has an identifier that matches a bitmask among the one or more bitmasks.
